(19) United States
(12) Patent Application Publication
(10) Pub. No.: US 2022/0224954 A1
(43) Pub. Date: Jul. 14, 2022

(54) EARLY WARNING IN MULTIMEDIA CONTENT

(71) Applicant: PREEMZ, LLC d/b/a ROW8, West Hollywood, CA (US)

(72) Inventors: John Calkins, Los Angeles, CA (US); David Rondan, Van Nuys, CA (US)

(21) Appl. No.: 17/584,106

(22) Filed: Jan. 25, 2022

Related U.S. Application Data
(63) Continuation of application No. PCT/US20/43624, filed on Jul. 24, 2020.
(60) Provisional application No. 62/878,693, filed on Jul. 25, 2019.

(51) Int. Cl. H04N 21/235; H04N 21/454; H04N 21/45; G06F 16/783

(52) U.S. Cl. CPC H04N 21/2353; G06F 16/783; H04N 21/4532; H04N 21/4542

(57) ABSTRACT

Provided herein are embodiments of systems, devices and methods for an early warning system, for example in-movie early warning system. The early warning system may be implemented in unedited films, or movies.

### CROSS-REFERENCE TO RELATED APPLICATIONS

The present application is a continuation of International Patent Application No. PCT/US20/43624, filed Jul. 24, 2020, which claims priority to U.S. Provisional Patent Application No. 62/878,693, filed Jul. 25, 2019, both of which are hereby expressly incorporated by reference in their entireties for all purposes.

### FIELD

The subject matter described herein relates generally to systems, devices, and methods for early warning system, and more specifically to parental early warning system in multimedia content.

### BACKGROUND

The existing MPAA rating system may be fine for categorizing films to enable viewer selection, but not well suited to helping actively manage exposure to mature content during viewing. And while a number of sites offer incremental information on the nature of the mature content in films, this information is again oriented towards enabling a choice of whether to view the films at all, not assisting with a viewing. To that end, the industry has tried to offer filtered versions of films, most notably for airplane viewing, but filmmakers have resisted moving filtered versions into the home, preferring artistically to have the full versions only.

Thus, needs exist for systems, devices, and methods to enable customers to watch unedited films, for example in the comfort of their own homes, without having to worry should children be present.

### SUMMARY

Provided herein are example embodiments of systems, devices and methods to enable customers to watch unedited multimedia contents, for example unedited films, with interactively and real-time warnings, for example in the comfort of their own homes. Although the present disclosure describes the features for films or movies, they may also be applied to other types of multimedia contents.

Generally, the system may provide a “Parent Alert” in-movie early warning system that gives parents who like to watch unedited movies at home with their children an early alert, for example, for “age sensitive” scenes that might be inappropriate moments for kids, within an otherwise acceptable film. The inappropriate moments may be, or may include, for example, sex, nudity, adult language, adult violence (gore, death, etc.), and so on. As a result, the system advantageously allows parents to enjoy films for “grown-ups” with their children in the room.

In some embodiments, with the feature(s) of the present disclosure (described in more detail below) enabled, a lower right screen icon may pop up to alert viewers that mature content is about to appear within the movie, and offer guidance when it is safe to resume watching and/or listening to the movie. In some embodiments, the features may use the icons or symbols of monkey figures.

In some embodiments, the present disclosure may also provide total counts of the symbols that appear in a movie. The present disclosure may provide the counts to the users for making decisions, for example watching a movie with a certain minimum or maximum number of symbols, for using the counts in a game, and so on.

In some embodiments, the present disclosure may include a computer-based method for in-movie early warning, comprising: recording one or more time-based events in a first file; parsing the first file to create a machine readable second file; packaging the second file with a digital media content file for playback; reading, by a plug-in module in a media player, the second file; and invoking, by the plug-in module, a desired behavior in the media player.

In some embodiments, the present disclosure may include a system for in-movie early warning, comprising: a server including at least one processor, a non-transitory computer-readable medium including computer-executable program instructions, and a network interface configured to operatively connect the server with a media player; and a data storage, the data storage storing at least a digital media content in a first file, wherein, when the computer-executable program instructions are executed by the at least one processor, the at least one processor: record one or more time-based events in a first file, parse the first file to create a machine readable second file, and package the second file with the digital media content file for playback; and wherein the media player: read, by a plug-in module in the media player, the second file, and invoke, by the plug-in module, a desired behavior in the media player.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS

The present disclosure may be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a high-level view of an exemplary high-level overview of a system in which the novel methods and system of an early warning system may find use, according to exemplary embodiments of the present disclosure.

FIG. 2 illustrates an exemplary Wise Monkeys symbols, according to exemplary embodiments of the present disclosure.

FIG. 3 illustrates an exemplary early warning system process, according to exemplary embodiments of the present disclosure.

FIG. 4 illustrates an exemplary overall platform in which various embodiments and process steps disclosed herein can be implemented, according to exemplary embodiments of the present disclosure.

### DETAILED DESCRIPTION

Generally, the present disclosure provides systems, devices and methods for an early warning system, for example in-movie early warning system. The early warning system may be implemented in unedited films, or movies.

In some embodiments, the early warning or “Parent Alert” system of the present disclosure may be a selectable service that may allow people with different backgrounds, age groups, etc., for example parents and their kids, to watch movies more easily together. In some embodiments, during the movie, five seconds before an “age sensitive” moment in the film, a visual warning marker may appear in the lower right of the screen. The warning may be specific to the type of scene coming up, and give a user time to take appropriate or desired action, for example, a parent may cover a child's ears or eyes, or pause the film to skip ahead past the scene.

Note that the time of five seconds is only an example. Another time period, for example, eight seconds, 10 seconds, etc. may be used. Also note that the location of the visual warning marker may be in a different location on the screen.

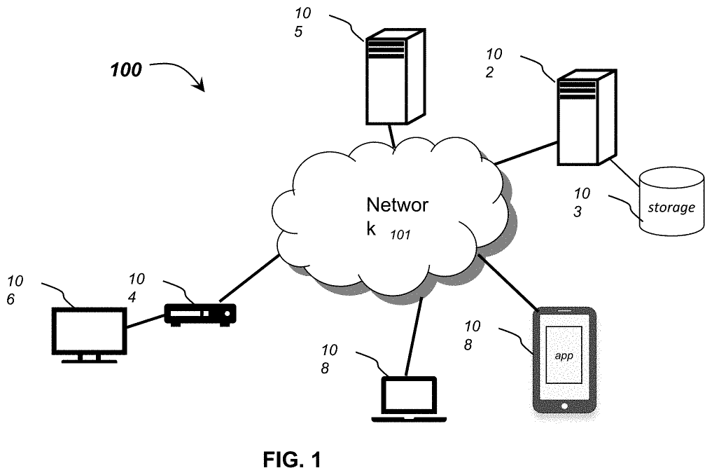

FIG. 1 illustrates an exemplary high-level overview of a system 100 in which the novel methods and system of the present disclosure may find use. The system 100 may generally include one or more servers 102 (or server for brevity), a third party server system 105, all may be distributed on one or more logical and/or physical servers, each having one or more processors, memory, data storage, an operating systems, input/output interfaces, network interfaces, and other components and modules implemented in hardware, software or combinations thereof. In some embodiments, the system 100 may be could-based and servers 102 may be a cloud server. The system 100 may further include a media player device 104, a display 106, and a plurality of customer computing devices 108 coupled to a network 101, for example the Internet and/or a cellular-based wireless network. The display 106 may be a TV or the like. The servers, media players and customer computing devices each may include one or more processors, memory, data storage, an operating system, input/output interfaces, network interfaces, engines and other components and modules implemented in hardware, software or combinations thereof. The servers, media players and customer computing devices may each further include non-transitory computer readable memory storing instructions that, when executed by a processor may perform one or more embodiments of the system 100 as described herein. The media players may also be implemented in software in a display or a customer computing device. The customer computing devices may include, for example, mobile devices, desktop or laptop devices. A mobile device may include smart phone, tablet, smart watch and other wearables.

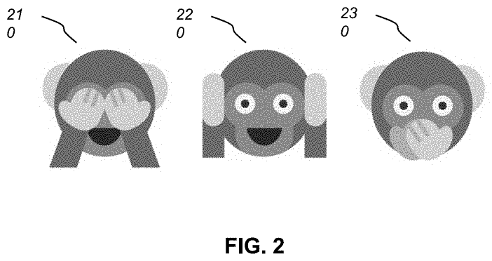

In some embodiments, the system may use family-friendly, and/or universally understood symbols or icons, for example “The Wise Monkeys”, to flag sensitive content during the film. The system may display the symbols in the lower right area/corner of the screen of a display or customer computing device (or screen for brevity). The system may also display the symbols in another area/corner of the screen so as not to disturb the viewing. The Wise Monkeys (hear no evil, speak no evil, see no evil) symbols may include “See No”, “Hear No”, “Speak No”, and “Fear No”. FIG. 2 illustrates an exemplary Wise Monkeys symbols, according to some embodiments. For example, the symbol representing “See No” will flag sex or nudity, “Hear No” may flag adult language, and “Speak No” may be modified to “Fear No” and indicate a violent scene. In some embodiments, monkey symbol “See No” 210 may appear to indicate that nudity and/or sexual content is about to appear. Monkey symbol “Hear No” 220 may appear to indicate that graphic language content is about to appear. Monkey symbol “Speak No” 230 may appear to indicate that violence and/or elements of fear content is about to appear. Other meanings for other uses may also be contemplated.

In some embodiments, the symbols may be highly stylized, friendly cartoonish. In some embodiments, the symbols may be static images, or dynamically change, blink, or fade in and out. Although the monkey figure examples are shown, other suitable symbols or icons may also be used.

It should be noted that the advantages of the present disclosure include at least the advantage that it does not alter or edit movies, nor does it skip any part of a movie. It is also an optional, selectable control to allow consumers to use the warning system or not use the warning system.

Behavior

In some embodiments, the early warning features of the present disclosure may be turned off/turned on, for example, by a toggle control that appears within a platform's player controls, for example similar to closed captioning controls. When the features are turned off, the movie would play as normal. When the features are turned on, the appropriate symbol(s) may appear at a predetermined time, for example five seconds, before the indicated content (for example, mature content) appears. In the case where multiple events happen simultaneously, two or more symbols may appear, all linked to a timecode that maps to the corresponding events.

File Format (.MKY File)

In some embodiments, events that need to be flagged may appear in a file in order of start-time, so a script of the system may only have to search up to the current time to get the state. In some embodiments, this (.MKY) file may store events and may be a sidecar file that is timecoded with events and evokes actions on the screen when the features are active. The structure of the file is different from other time-based files. Some time-based files, for example only have a single time code with a text to display. On the other hand, in some embodiments, the .MKY file may have at least a time code with a start time and end time, an action to display, reason for display (such as description of event happening on screen), and varying levels of sensitivity. With the .MKY file and a file interpreter within the media player, much more “event evaluation” may be done by the system in order to display the proper warning.

The multimedia or media player is broadly defined in this disclosure and may include software, hardware or a combination thereof. It may be or may include, for example, a DVD player, a streaming service, etc.

As another technical improvement of the present disclosure, for example over other time-based methods, in some embodiments, the system of the present disclosure may also be able to play multiple events at a time. For example, the system does not stop when it sees a window with the current time, instead it looks for a window starting after the current time.

In some embodiments, the appropriate “monkey” event may be mapped to the timecode with a predetermined (e.g., 5 seconds) lead time to display on screen if the features are turned “on”. The timecoded, proprietary file may then be read by a player and platform-based plug-in to display the appropriate symbol (e.g., a monkey symbol) based on the event. There may also be an end-time for the “monkey” event to cease displaying, informing the viewer (e.g., a parent) that the child can resume watching.

Record Format for .MKY File

In some embodiment, the file format of the system of the present disclosure may comprise: HH:MM:SS:MS-->HH:MM:SS:MS-SymbolID//Comments (Comments are optional). Where HH is the hour, MM is the minutes, SS is the seconds and MS is the milliseconds. They indicate the start time and end time of an event. SymbolID indicates which symbol to display.

Process

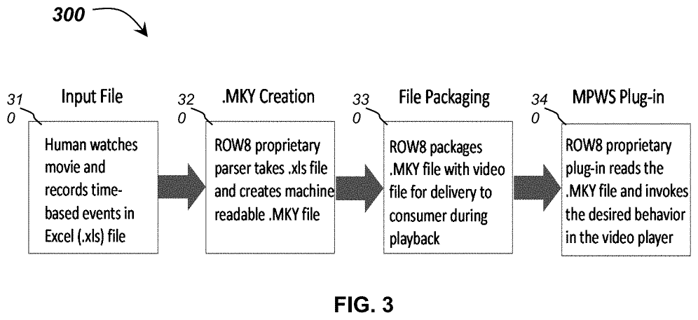

FIG. 3 illustrates an exemplary process 300 of the present disclosure. In some embodiments, the process 300 may include Step 310 logging events, Step 320 creating a .MKY file, Step 330 packaging the .MKY file with a multimedia content (e.g., a video) file for playback, and Step 340 of a plug-in module reading the .MKY file to invoke the described behavior. In some embodiments, the Steps of logging events 310, creating a .MKY file 320, and packaging the file with a multimedia content 330 may be performed at or by the server. The multimedia content file may be retrieved from a third party's server. In some embodiments, the initial Step of movie screening and event logging 310 may be done manually by a human.

In some embodiments, identifying language or event can be automatically logged by the system. Once the event log has been created, it may be automatically transformed by a .MKY parser to put it into machine readable format. A custom plug-in may read the .MKY file and display the desired graphic and text within the multimedia player.

In some embodiments, the system of present disclosure may also provide total counts of the symbols that appear in a media content, for example a movie. The system may provide the counts to the users for making decisions, for example watching a movie with a certain minimum or maximum number of symbols, for using the counts in a game, and so on.

Although the time-coded file is shown being received, recorded or created in the system, for example at a server, in some embodiments, the time-coded file may be delivered, or purchased by the consumer separately. In these embodiments, the integration or provision of the time-coded file with the media content may occur at a third-party or on the consumer-side, for example at the media player or a connected device. In some embodiments, the integration may be done in real-time.

System Architecture

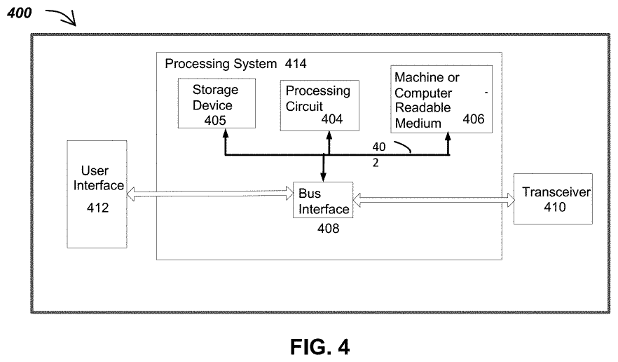

FIG. 4 illustrates an exemplary overall platform 400 in which various embodiments and process steps disclosed herein can be implemented. In accordance with various aspects of the disclosure, a device, component or element, or any portion of a device, component or element, or any combination of devices, components or elements may be implemented with a processing system 414 that includes one or more processing circuits 404. Processing circuits 404 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 404 may be used to implement any one or more of the various embodiments, systems, algorithms, and processes described above, for example as illustrated in at least FIG. 3.

In the example of FIG. 4, the processing system 414 may be implemented with a bus architecture, represented generally by the bus 402. The bus 402 may include any number of interconnecting buses and bridges depending on the specific application of the processing system 414 and the overall design constraints. The bus 402 may link various circuits including one or more processing circuits (represented generally by the processing circuit 404), the storage device 405, and a machine-readable, processor-readable, processing circuit-readable or computer-readable media (represented generally by a non-transitory machine-readable medium 406). The bus 402 may also link various other circuits such as timing sources, peripherals, voltage regulators, and power management circuits, which are well known in the art, and therefore, will not be described any further. The bus interface 408 may provide an interface between bus 402 and a transceiver 410. The transceiver 410 may provide a means for communicating with various other apparatus over a transmission medium. Depending upon the nature of the apparatus, a user interface 412 (e.g., keypad, display, speaker, microphone, touchscreen, motion sensor) may also be provided.

The processing circuit 404 may be responsible for managing the bus 402 and for general processing, including the execution of software stored on the machine-readable medium 406. The software, when executed by processing circuit 404, causes processing system 414 to perform the various functions described herein for any particular apparatus. Machine-readable medium 406 may also be used for storing data that is manipulated by processing circuit 404 when executing software.

One or more processing circuits 404 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The embodiments of the present disclosure reflect an inventive concept in the arrangements and combination of the devices, components and method steps utilized in in-movie early warning system. The embodiments of the present disclosure also provide for improvements over prior modes in the field of in-movie early warning system. These improvements can include, for example, optimization of computer resources, improved data accuracy and improved data integrity, to name only a few. In a number of embodiments, instructions stored in the memory of computing devices (e.g., software) can cause one or more processors of the system to perform the steps of the embodiments described herein, for example as illustrated in at least FIG. 3.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

What is claimed is:

1. A computer-based method for in-movie early warning, comprising:
recording one or more time-based events in a first file;
parsing the first file to create a machine readable second file;
packaging the second file with a digital media content file for playback;
reading, by a plug-in module in a media player, the second file; and
invoking, by the plug-in module, a desired behavior in the media player.

2. The computer-based method of claim 1, wherein the first file is an Excel (.xls) file.

3. The computer-based method of claim 1, wherein the second file comprises records in the format of HH:MM:SS:MS-->HH1:MM1:SS1:MS1-SymbolID.

4. The computer-based method of claim 3, wherein HH:MM:SS:MS is a start time, and HH1:MM1:SS1:MS1 is an end time.

5. The computer-based method of claim 1, wherein the invoking the desired behavior in the media player is done at a predetermined time before an event of the one or more time-based events.

6. The computer-based method of claim 1, wherein the desired behavior comprises displaying a predetermined symbol based on a content of the digital media content file.

7. The computer-based method of claim 6, wherein the symbol comprises one of a hear no evil, speak no evil, and see no evil monkey character.

8. The computer-based method of claim 6, wherein the symbol indicates one of graphic language content, nudity/sexual content, and violence/elements of fear content.

9. The computer-based method of claim 1, wherein the early warning is selectable.

10. The computer-based method of claim 1, wherein the digital media content is an unedited movie.

11. The computer-based method of claim 1, wherein the second file is a sidecar file to the digital media content file.

12. A system for in-movie early warning, comprising:
a server including at least one processor, a non-transitory computer-readable medium including computer-executable program instructions, and a network interface configured to operatively connect the server with a media player; and a data storage, the data storage storing at least a digital media content in a first file, wherein, when the computer-executable program instructions are executed by the at least one processor, the at least one processor:
record one or more time-based events in a first file,
parse the first file to create a machine readable second file, and
package the second file with the digital media content file for playback; and
wherein the media player:
read, by a plug-in module in the media player, the second file, and
invoke, by the plug-in module, a desired behavior in the media player.

13. The system of claim 12, wherein the second file comprises records in the format of HH:MM:SS:MS-->HH1:MM1:SS1:MS1-SymbolID.

14. The system of claim 12, wherein the invoking the desired behavior in the media player is done at a predetermined time before an event of the one or more time-based events.

15. The system of claim 12, wherein the digital media content is an unedited movie.
